(19) United States
(12) Patent Application Publication
(10) Pub. No.: US 2026/0326769 A1
(43) Pub. Date: Oct. 22, 2026

(54) METHOD FOR VEHICLE LATERAL VELOCITY AND YAW RATE ESTIMATION

(71) Applicants: FCA US LLC, Auburn Hills, MI (US); Stellantis Auto SAS, Poissy (FR)

(72) Inventor: Lubna S. Khasawneh, Auburn Hills, MI (US)

(21) Appl. No.: 19/181,533

(22) Filed: Apr. 17, 2025

(51) Int. Cl. B60W 40/114; G06F 17/11; G06F 17/16

(52) U.S. Cl. CPC B60W 40/114; G06F 17/11; G06F 17/16; B60W 2520/10; B60W 2520/125; B60W 2520/14

(57) ABSTRACT

A method for estimating lateral velocity and yaw rate for a vehicle with a nonlinear dynamical bicycle model, includes, determining a state Jacobian of a system matrix using Taylor series expansion, determining a measurement matrix Jacobian using Taylor series expansion and initializing a state vector and a covariance matrix for a third order system. The method also includes updating the state Jacobian as a function of a measured lateral acceleration, a measured yaw rate and a measured longitudinal vehicle speed, predicting a next state vector and an error covariance, updating the measurement matrix Jacobian, determining a residual covariance and a Kalman gain, obtaining the measured lateral acceleration and the measured yaw rate, determining a measurement residual error, and estimating the lateral velocity and the yaw rate of the vehicle.

### FIELD

The present disclosure relates to estimation of vehicle lateral velocity and yaw rate.

### BACKGROUND

Vehicle accelerations are measured by one or more sensors. Acceleration determinations are used in various vehicle control systems and schemes and accurate determinations can improve vehicle dynamics and control. Acceleration sensors can have a bias or offset, and can provide noisy output signals/data, whereby output from the sensor is different than the actual value of the parameter detected by the sensor. This sensor measurement error can affect performance of systems that utilize the senor outputs.

### SUMMARY

In at least some implementations, a method for estimating lateral velocity and yaw rate for a vehicle, with a nonlinear dynamical bicycle model, includes, determining a state Jacobian of a system matrix using Taylor series expansion, determining a measurement matrix Jacobian using Taylor series expansion and initializing a state vector and a covariance matrix for a third order system. The method also includes updating the state Jacobian as a function of a measured lateral acceleration, a measured yaw rate and a measured longitudinal vehicle speed, predicting a next state vector and an error covariance, updating the measurement matrix Jacobian, determining a residual covariance and a Kalman gain, obtaining the measured lateral acceleration and the measured yaw rate, determining a measurement residual error, and estimating the lateral velocity and the yaw rate of the vehicle.

In at least some implementations, the method also includes updating the covariance matrix and the state vector with the estimated lateral velocity and the estimated yaw rate.

In at least some implementations, the method also includes, to provide an updated estimation of the lateral velocity and an updated estimation of the yaw rate, performing again the steps of, updating the state Jacobian as a function of a measured lateral acceleration, a measured yaw rate, a measured steering angle and a measured longitudinal vehicle velocity, predicting a next state vector and an error covariance, updating the measurement matrix Jacobian, determining a residual covariance and a Kalman gain, obtaining the measured lateral acceleration and the measured yaw rate, determining a measurement residual error, and estimating the lateral velocity and the yaw rate of the vehicle.

In at least some implementations, the method also includes providing an output to a control system including the estimated lateral velocity and the estimated yaw rate.

In at least some implementations, the measured lateral acceleration and the measured yaw rate are obtained from an accelerometer of the vehicle.

In at least some implementations, the accelerometer is an inertial measurement unit (IMU).

In at least some implementations, the dynamical bicycle model is discretized using Euler approximation.

In at least some implementations, in the step of initializing the state vector, the state vector is initialized to zero.

In at least some implementations, the covariance matrix is an identity 3×3 matrix given by

$${I}_{3} = [ \begin{matrix}1 & 0 & 0 \\ 0 & 1 & 0 \\ 0 & 0 & 1\end{matrix} ] .$$

In at least some implementations, the state vector is given by

$$x ( k ) = [ \begin{matrix}{V}_{y} ( k ) \\ \dot{ψ} ( k ) \\ {V}_{x} ( k )\end{matrix} ] ,$$

where V_{y} is the vehicle lateral velocity, Vₓ is the vehicle longitudinal velocity \dot{ψ} is the yaw rate at time (k).

In at least some implementations, the measured lateral acceleration (a_{y}) is related to vehicle lateral velocity (V_{y}) and vehicle yaw rate (\dot{ψ}) by the equation: a_{y}=\dot{V}_{y}+Vₓ\dot{ψ}, where Vₓ is the vehicle longitudinal velocity. In at least some implementations,

$${\dot{V}}_{y} = ( \frac{- {C}_{f} - {C}_{r}}{{M}_{v} {V}_{x}} ) {V}_{y} + ( \frac{- {aC}_{f} + {bC}_{r}}{{M}_{v} {V}_{x}} - {V}_{x} ) \dot{ψ} + ( \frac{{C}_{f}}{{M}_{v}} ) {δ}_{f} ,$$

$$and$$

$$\ddot{ψ} = ( \frac{- a {C}_{f} + b {C}_{r}}{{I}_{zz} {V}_{x}} ) {V}_{y} + ( \frac{- {a}^{2} {C}_{f} - {b}^{2} {C}_{r}}{{I}_{zz} {V}_{x}} ) \dot{ψ} + ( \frac{{aC}_{f}}{{I}_{zz}} ) {δ}_{f} ,$$

where: \ddot{ψ}=vehicle yaw angular acceleration; a=distance from a center of gravity to a front axle of the vehicle; b=distance from the center of gravity to a rear axle; Mᵥ=vehicle mass; I_{zz}=vehicle moment of inertia about the z axis; C_{f}=lumped cornering stiffnesses of a front tire; Cᵣ=lumped cornering stiffnesses of a rear tire; and δ_{f}=the steering angle.

In at least some implementations, a measurement model is given by:

$$[ \begin{matrix}\dot{ψ} \\ {a}_{y}\end{matrix} ] = {\underbrace{[ \begin{matrix}0 & 1 \\ \frac{- {C}_{f} - {C}_{r}}{{M}_{v} {V}_{x}} & \frac{- {aC}_{f} + {bC}_{r}}{{M}_{v} {V}_{x}}\end{matrix} ]}}_{C} [ \begin{matrix}{V}_{y} \\ \dot{ψ}\end{matrix} ] + [ \begin{matrix}{V}_{y} \\ \frac{{C}_{f}}{{M}_{v}}\end{matrix} ] {δ}_{f} ,$$

and the step of determining a measurement matrix Jacobian using Taylor series expansion is given by:

$${C}_{J} = [ \begin{matrix}0 & 1 & 0 \\ \frac{- {C}_{f} - {C}_{r} 0}{{M}_{v} {V}_{x} ( k )} & \frac{- a {C}_{f} + b {C}_{r}}{{M}_{v} {V}_{x} ( k )} & \frac{( {C}_{f} + {C}_{r} ) {V}_{y} ( k ) + ( a {C}_{f} - b {C}_{r} ) \dot{ψ} ( k )}{{M}_{v} {{V}_{x}}^{2} ( k )}\end{matrix} ] ,$$

where: a=distance from a center of gravity to a front axle of the vehicle; b=distance from the center of gravity to a rear axle; Mᵥ=vehicle mass; C_{f}=lumped cornering stiffnesses of a front tire; Cᵣ=lumped cornering stiffnesses of a rear tire; and δ_{f}=the steering angle.

In at least some implementations, a method for estimating lateral velocity and yaw rate for a vehicle includes defining a dynamical bicycle model for a vehicle system with variable longitudinal velocity and two degrees of freedom, where the degrees of freedom relate to lateral velocity and yaw angle, and where a state representation of the system is given by \dot{x}=Ax+Bu, A is a system matrix that is nonlinear, applying Taylor series expansion to linearize the A system matrix, defining a nonlinear Kalman filter for the system including a measurement model with a measurement matrix C, applying Taylor series expansion to linearize the measurement matrix C, and estimating the lateral velocity and the yaw rate of the vehicle as a function of the dynamical bicycle model and the nonlinear Kalman filter.

In at least some implementations, the step of estimating includes determining a state Jacobian of the system matrix A, determining a Jacobian of the measurement matrix C, initializing a state vector and a covariance matrix for the system, updating the state Jacobian as a function of a measured lateral acceleration, a measured yaw rate and a measured longitudinal vehicle speed, predicting a next state vector and an error covariance, updating the measurement matrix Jacobian, determining a residual covariance and a Kalman gain, obtaining the measured lateral acceleration and the measured yaw rate, and determining a measurement residual error.

In at least some implementations, the predicted lateral acceleration

$${\dot{V}}_{y} = ( \frac{- {C}_{f} - {C}_{r}}{{M}_{v} {V}_{x}} ) {V}_{y} + ( \frac{- {aC}_{f} + {bC}_{r}}{{M}_{v} {V}_{x}} - {V}_{x} ) \dot{ψ} + ( \frac{{C}_{f}}{{M}_{v}} ) {δ}_{f} ,$$

and the yaw angle acceleration

$$\ddot{ψ} = ( \frac{- a {C}_{f} + b {C}_{r}}{{I}_{zz} {V}_{x}} ) {V}_{y} + ( \frac{- {a}^{2} {C}_{f} - {b}^{2} {C}_{r}}{{I}_{zz} {V}_{x}} ) \dot{ψ} + ( \frac{{aC}_{f}}{{I}_{zz}} ) {δ}_{f} ,$$

and a state space representation of the system is given by \dot{x}=Ax+Bu; wherein:

$${\underbrace{[ \begin{matrix}{\dot{V}}_{y} \\ \ddot{ψ}\end{matrix} ]}}_{x} = {\underbrace{[ \begin{matrix}- \frac{{C}_{f} + {C}_{r}}{{M}_{v} {V}_{x}} & \frac{- {aC}_{f} + {bC}_{r}}{{M}_{v} {V}_{x}} - {V}_{x} \\ \frac{- {aC}_{f} + {bC}_{r}}{{I}_{zz} {V}_{x}} & \frac{- {a}^{2} {C}_{f} + {b}^{2} {C}_{r}}{{I}_{zz} {V}_{x}}\end{matrix} ]}}_{A} {\underbrace{[ \begin{matrix}{V}_{y} \\ \dot{ψ}\end{matrix} ]}}_{x} + {\underbrace{[ \begin{matrix}\frac{{C}_{f}}{{M}_{v}} \\ \frac{{aC}_{f}}{{I}_{zz}}\end{matrix} ]}}_{B} {\underbrace{{δ}_{f}}}_{u} ,$$

where A is a system matrix and where: \dot{ψ}=vehicle yaw rate; \ddot{ψ}=vehicle yaw angular acceleration; Vₓ=vehicle velocity component along the x axis (longitudinal velocity); V_{y}=vehicle velocity component along the y axis (lateral velocity); a=distance from center of gravity to front axle; b=distance from center of gravity to rear axle; Mᵥ=vehicle mass; I_{zz}=vehicle moment of inertia about the z axis; C_{f}=lumped cornering stiffnesses of the front tire; Cᵣ=lumped cornering stiffnesses of the rear tire; and δ_{f}=front tire steering angle.

In at least some implementations, lateral acceleration a_{y}=\dot{ψ}_{y}+Vₓ\dot{ψ}, and a measurement model is defined in state space representation as:

$$[ \begin{matrix}\dot{ψ} \\ {a}_{y}\end{matrix} ] = {\underbrace{[ \begin{matrix}0 & 1 \\ \frac{- {C}_{f} - {C}_{r}}{{M}_{v} {V}_{x}} & \frac{- {aC}_{f} + {bC}_{r}}{{M}_{v} {V}_{x}}\end{matrix} ]}}_{C} [ \begin{matrix}{V}_{y} \\ \dot{ψ}\end{matrix} ] + [ \begin{matrix}{V}_{y} \\ \frac{{C}_{f}}{{M}_{v}}\end{matrix} ] {δ}_{f} ,$$

wherein C is a measurement matrix.

In at least some implementations, the method includes determining a state Jacobian Aⱼ which is the Jacobian of the system matrix A using Taylor series expansion and determining a measurement Jacobian Cⱼ which is the Jacobian of the measurement matrix C using Taylor series expansion.

In at least some implementations, the method includes:
initializing the state vector as

$$x ( 0 ) = [ \begin{matrix}{V}_{y} ( 0 ) \\ \dot{ψ} ( 0 ) \\ {V}_{x} ( 0 )\end{matrix} ] ,$$

and initializing the error covariance matrix

$$P as {I}_{3} = [ \begin{matrix}1 & 0 & 0 \\ 0 & 1 & 0 \\ 0 & 0 & 1\end{matrix} ] ;$$

defining a process covariance Q and a measurement covariance R;
updating the state Jacobian Aⱼ and predicting the next state vector as

$$x ( k + 1 ) = ( {I}_{3} + {T}_{s} {A}_{j} ) [ \begin{matrix}{V}_{y} ( k ) \\ \dot{ψ} ( k ) \\ {V}_{x} ( k )\end{matrix} ] + [ \begin{matrix}\frac{{C}_{f}}{{M}_{v}} \\ \frac{{aC}_{f}}{{I}_{zz}} \\ 0\end{matrix} ] {δ}_{f} ,$$

and predicting the next error covariance matrix as

$$P ( k + 1 ) = {A}_{J} P ( k ) {A}_{J}^{T} + Q ;$$

updating the measurement Jacobian Cⱼ and determining a residual covariance and a Kalman gain as

$$S = {C}_{J} P ( k ) {C}_{J}^{T} + R ; and K = P ( k ) {C}_{J}^{T} {S}^{- 1} ;$$

and
computing the measurement residual error based on measured values for lateral acceleration and yaw rate, where the measurement residual error ϵ=y−Cⱼx(k).

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 illustrates a vehicle with various components and systems diagrammatically shown;

FIG. 2 is a diagrammatic view of a control system of the vehicle;

FIG. 3 is a flowchart of a method for estimating lateral velocity and yaw rate in a vehicle; and

FIG. 4 is a flowchart of a method for estimating lateral velocity and yaw rate in a vehicle.

### DETAILED DESCRIPTION

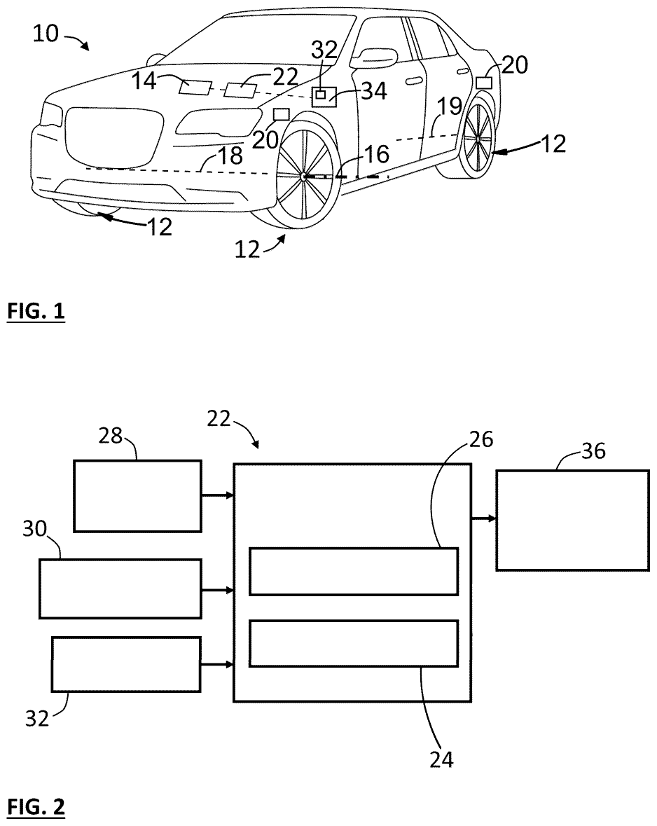

Referring in more detail to the drawings, FIG. 1 illustrates a vehicle 10 that includes multiple wheels 12, and a propulsion system 14 including a motor, an engine, and/or a transmission that provides torque to the wheels 12 to rotate the wheels about an axis of rotation 16 and accelerate the vehicle 10. In the example shown, the vehicle includes two front wheels 12 that are mounted on a front axle 18, and two rear wheels 12 that are mounted on a rear axle 19. The vehicle 10 may also include one or more brake assemblies (e.g. a brake system 20) to decelerate the vehicle 10.

Various sensors may provide information about vehicle dynamics. For example, vehicle speed and acceleration may be determined by one or more wheel speed sensors 28 (FIG. 2) and one or more accelerometers 30. Additionally, steering angle may be determined by one or more steering angle sensors 32. These sensors, among other things, may be communicatively coupled with a controller 22 or control system (e.g., an engine control module). The controller 22 and sensors 28, 30, 32 may be used in control of one or move vehicle functions or systems, like anti-lock brakes, vehicle stability control and the like. The controller 22 may be arranged to receive sensor information and provide information to another system to, for example, trigger diagnostic fault codes for a user in the event of a malfunction of a vehicle component or system (e.g., a malfunctioning vehicle lateral accelerometer or steering angle sensor). The controller 22 may include a memory 24 for storing data from the one or more sensors and a processor 26 for processing the data stored in the memory.

In order to perform the functions and desired processing set forth herein, as well as the computations therefore, the controller 22 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 22 may include input signal processing and filtering to enable accurate sampling and conversion or acquisitions of such signals from communications interfaces and sensors. As used herein the terms controller 22 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

As shown in FIG. 2, to permit measurement of the rotational speed of the wheels 12, the wheel speed sensor 28 may be associated with one of the wheels 12 to provide an output to the controller 22 that is indicative of the rotation of the wheel. By way of a non-limiting example, the wheel speed sensor 28 may be a hall effect sensor with a magnet being rotated with the wheel or spindle and with a sensing element used to detect the magnet as it rotates by the sensing element. Of course, other types of rotational speed sensors may be used.

Additionally, acceleration may be measured using the lateral accelerometer sensor 30 which measures gravitational forces (i.e., g-forces) in cross-car directions, and/or other directions. The vehicle 10 may include more than one lateral accelerometer 30 arranged in or on the vehicle 10. In at least one embodiment, the lateral accelerometer sensor 30 may be a multi-axis accelerometer which provides simultaneous measurement of acceleration in three perpendicular axes, for example. The lateral accelerometer 30 may measure normal acceleration which arises when the vehicle is turning a corner or switching lanes on the highway, for example.

To measure the position of wheels, the steering angle sensor 32 may be associated with one or more of the wheels 12 or with a steering shaft 34 of the vehicle 10. In at least one embodiment, the steering angle sensor may be a giant magnetoresistance (GMR) device, by way of one non-limiting example, that provides an absolute steering angle value over the complete steering angle range. Other types of sensors may be used, for example but not limited to, tunnel magnetoresistance (TMR) sensors and anisotropic magnetoresistance (AMR) sensors. The steering angle sensor 32 may provide an output that permits steering angle and/or steering angle velocity or rate of change of steering angle to be determined at the controller 22.

One or more systems 36 of vehicle 10 may rely on the vehicle acceleration and/or steering angle data from the lateral accelerometer sensor 30 and/or steering angle sensor 32 during operation or during travel of the vehicle 10. For instance, an anti-lock braking system (ABS), traction control system (TC), electronic stability control system (ESC), on-board diagnostic monitors (OBD), torque security features, cruise control (CC), adaptive cruise control (ACC), acceleration control, and/or autonomous vehicle systems (AVS) may utilize some or all of the data from the accelerometer 30, wheel speed sensors, and/or steering angle sensor 32.

In more detail, vehicle trajectory planning and lateral control systems rely on lateral velocity and yaw rate feedback for enhancing lateral stability performance. Automatic steering systems such as lane keeping, lane centering, and trajectory following attempt to ensure that the actual yaw rate and lateral velocity of the vehicle track a desired yaw rate and a desired lateral velocity determined by the trajectory planning system. Lack of accuracy on those signals can cause poor lateral control performance, which might cause deviation of the vehicle trajectory from the planned trajectory and might lead to instability of the vehicle lateral motion. For example, the sensor data may be used in feedback or feedforward control schemes and incorrect data can lead to poor or inaccurate control behavior.

Vehicle lateral velocity cannot be directly measured by inexpensive sensors. High-cost sensors can measure lateral velocity, such as optical sensors, but are too expensive for use in production vehicles. Direct calculations of lateral velocity from other sensors without corrections does not give satisfactory results. Obtaining lateral velocity by integrating lateral acceleration measurement does not work because the integration error grows with time and causes a big drift in the output. Thus, sensor fusion that provides correction of output values is needed for lateral velocity estimation.

Additionally, vehicle yaw rate can be measured from onboard inexpensive sensors such as IMUs, however, they don't provide very accurate outputs. IMU signals usually are very noisy, and they have an offset (e.g. a difference between measured and actual value). This offset can have both static (e.g. some value outputted when zero should be outputted) and dynamic (e.g. a different or offset that varies as a function of one or more dynamic variables, such as different speeds, temperatures, etc.) components. So the offset is not a constant value that can be simply subtracted from the signal, but is time varying and can change on road vehicles with temperature. It can also change with sensor aging.

The so-called bicycle model can be used to calculate longitudinal acceleration, lateral acceleration, and yaw motion, using a rigid two-axle, single track vehicle body model. The model accounts for body mass, aerodynamic drag, and weight distribution between the axles due to acceleration and steering. This model assumes that the longitudinal velocity is constant (that is, not changing) and so the longitudinal acceleration is zero. However, the vehicle speed is not constant in use of vehicles, so gain scheduling is needed in order to use the bicycle model to design a linear observer, such as a linear Kalman filter.

This gain scheduling requires creating look up tables for the longitudinal velocity range of driving, for example 0-130 kph, to cover the range of driving speeds on highways and local roads. For this range, breakpoints can be created for the look up table. Each break point of longitudinal velocity requires different observer gains, so the observer must be tuned for every breakpoint. Interpolation can be done in between breakpoints and the farther the velocity points are spaced, the less accurate are the results. Adding more breakpoints might improve the accuracy but requires greater cost of calibration, greater time and effort and memory space. This is a very time and effort consuming process, the accuracy varies, and it is vehicle specific such that the effort is needed for each vehicle.

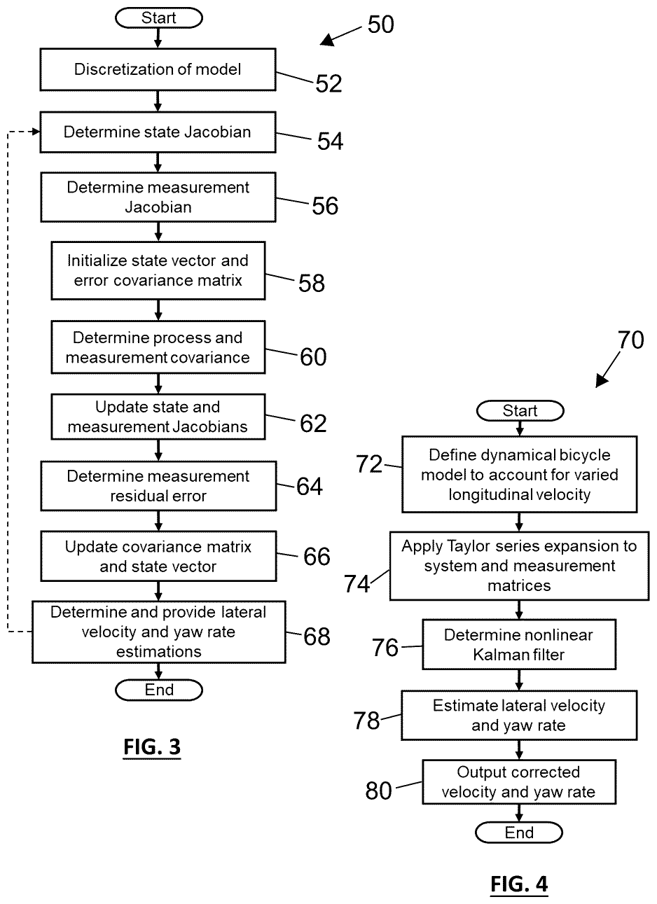

In the method shown in FIGS. 3 and 4, the longitudinal velocity is not set to be constant, so the bicycle model is no longer linear, and is made linear by using Taylor series expansion and a designed, nonlinear observer/Kalman filter (e.g. Extended Kalman Filter (EKF)). Taylor series expansion is based on an infinite sum of terms that are expressed in terms of a function's derivatives at a point. With this method, observer gains need not be separately determined for every speed breakpoint, and look up tables and gain scheduling are not needed, nor is interpolation between breakpoints. The method enables accurate estimation of both lateral velocity and yaw rate, using the nonlinear Kalman filter (EKF) in a vehicle bicycle model to fused with measurements that can be obtained from onboard, inexpensive sensors, such as the IMU(s), wheel speed sensor(s) and steering angle sensor(s).

In at least some implementations, the algorithm and model developed herein can reside in a suitable control unit, such as an Adapted mPAD (Modular Package for Autonomous Driving) ECU and may utilize data/signal outputs from inexpensive sensors via a vehicle communications network (e.g. CAN). A measured longitudinal velocity may be obtained from the wheel speed sensor(s) located in the Brake System Module (BSM), steering angle may be obtained from the steering angle sensor located in a vehicle steering column, and yaw rate and lateral acceleration may be obtained from the IMU. The output of the model/algorithm can be used, for example, in lateral control and path planning, which may be done in an mPAD ECU or other controller/control system. Of course, other implementations are possible and will be apparent in view of this disclosure.

In the algorithm/method, a bicycle model of vehicle lateral dynamics with two degrees of freedom is used. The two degrees of freedom are lateral velocity, denoted by V_{y}, and yaw angle, denoted by ψ. Equations for both include:

$${\dot{V}}_{y} = ( \frac{- {C}_{f} - {C}_{r}}{{M}_{v} {V}_{x}} ) {V}_{y} + ( \frac{- a {C}_{f} + b {C}_{r}}{{M}_{v} {V}_{x}} - {V}_{x} ) \dot{ψ} + ( \frac{{C}_{f}}{{M}_{v}} ) {δ}_{f} ; and \qquad ( equation 1 )$$

$$\ddot{ψ} = ( \frac{- a {C}_{f} + b {C}_{r}}{{I}_{zz} {V}_{x}} ) {V}_{y} + ( \frac{- {a}^{2} {C}_{f} - {b}^{2} {C}_{r}}{{I}_{zz} {V}_{x}} ) \dot{ψ} + ( \frac{a {C}_{f}}{{I}_{zz}} ) {δ}_{f} . \qquad ( equation 2 )$$

The state space representation of the system is given by: \dot{x}=Ax+Bu;

$$\underbrace{[ \begin{matrix}{\dot{V}}_{y} \\ \ddot{ψ}\end{matrix} ]}_{\dot{x}} = \underbrace{[ \begin{matrix}- \frac{{C}_{f} + {C}_{r}}{{M}_{v} {V}_{x}} & \frac{- a {C}_{f} + b {C}_{r}}{{M}_{v} {V}_{x} ( k )} - {V}_{x} \\ \frac{- a {C}_{f} + b {C}_{r}}{{I}_{zz} {V}_{x}} & - \frac{{a}^{2} {C}_{f} - {b}^{2} {C}_{r}}{{I}_{zz} {V}_{x}}\end{matrix} ]}_{A} \underbrace{[ \begin{matrix}{V}_{y} \\ \dot{ψ}\end{matrix} ]}_{x} + \underbrace{[ \begin{matrix}\frac{{C}_{f}}{{M}_{v}} \\ \frac{{aC}_{f}}{{I}_{zz}}\end{matrix} ]}_{B} \underbrace{{δ}_{f}}_{u} ; \qquad ( equation 3 )$$

where:
ψ=vehicle yaw angle;
\dot{ψ}=vehicle yaw rate;
\ddot{ψ}=vehicle yaw angular acceleration;
Vₓ=vehicle velocity component along the x axis (longitudinal velocity);
V_{y}=vehicle velocity component along the y axis (lateral velocity);
a=distance from center of gravity to front axle;
b=distance from center of gravity to rear axle;
Mᵥ=vehicle mass;
I_{zz}=vehicle moment of inertia about the z axis;
C_{f}=lumped cornering stiffnesses of the front tire;
Cᵣ=lumped cornering stiffnesses of the rear tire; and
δ_{f}=front tire steering angle.

In the methods used herein, the longitudinal velocity Vₓ is not assumed to be constant, and the system is not linear. Accordingly, the A matrix (from equation 3) is not linear, and a nonlinear Kalman filter (e.g. an EKF) is needed. With the nonlinear Kalman filter, the nonlinear system matrix A is linearized around the operating point at every time step using Taylor series expansion, and is updated at every time step, rather than considering it constant as is done in the basic bicycle model. Because the longitudinal speed is not assumed to be constant, it is considered as an additional system state, so the system/algorithm is a third order system instead of a second order system.

The method fuses the dynamical bicycle model of vehicle lateral dynamics given in equation 3, above, with measurements for both lateral acceleration and yaw rate. The lateral acceleration a_{y} is related to the system states [V_{y} \dot{ψ}] according to the following equation 4:

a_{y}=\dot{V}_{y}+Vₓ\dot{ψ}

Substituting \dot{V}_{y} from equation 1 yields, as equation 5:

$${a}_{y} = ( \frac{- {C}_{f} - {C}_{r}}{{M}_{v} {V}_{x}} ) {V}_{y} + ( \frac{- {aC}_{f} + {bC}_{r}}{{M}_{v} {V}_{x}} - {V}_{x} ) \dot{ψ} + ( \frac{{C}_{f}}{{M}_{v}} ) {δ}_{f} + {V}_{x} \dot{ψ} = ( \frac{- {C}_{f} - {C}_{r}}{{M}_{v} {V}_{x}} ) {V}_{y} + ( \frac{- {aC}_{f} + {bC}_{r}}{{M}_{v} {V}_{x}} ) \dot{ψ} + ( \frac{{C}_{f}}{{M}_{v}} ) {δ}_{f} .$$

The resulting measurement model in state space representation is given by equation 6:

$$[ \begin{matrix}\dot{ψ} \\ {a}_{y}\end{matrix} ] = {\underbrace{\begin{matrix}[ \begin{matrix}0 & 1 \\ \frac{- {C}_{f} - {C}_{r}}{{M}_{v} {V}_{x}} & \frac{- {aC}_{f} + {bC}_{r}}{{M}_{v} {V}_{x}}\end{matrix} ] & \end{matrix}}}_{C} [ \begin{matrix}{V}_{y} \\ \dot{ψ}\end{matrix} ] + [ \begin{matrix}0 \\ \frac{{C}_{f}}{{M}_{v}}\end{matrix} ] {δ}_{f} .$$

Given the system model in equation 3 and the measurement model in equation 6, the extended Kalman filter is formulated to enable estimating vehicle lateral velocity and yaw rate. To linearize the nonlinear model, Taylor series expansion is used. Thus, the Jacobian of both the system matrix A and the measurement matrix C, are determined, as indicated below.

In the method 50, step 52 involves discretization of the system dynamical bicycle model given in equations 1 and 2. In the example described this is done using Euler approximation, which yields

$${V}_{y} ( k + 1 ) = {V}_{y} ( k ) + {T}_{s} ( ( \frac{- {C}_{f} - {C}_{r}}{{M}_{v} {V}_{x} ( k )} ) {V}_{y} ( k ) + ( \frac{- {aC}_{f} + {bC}_{r}}{{M}_{v} {V}_{x} ( k )} - {V}_{x} ( k ) ) \dot{ψ} ( k ) + ( \frac{{C}_{f}}{{M}_{v}} ) {δ}_{f} ) ; \qquad equation 7$$

$$and$$

$$\dot{ψ} ( k + 1 ) = \dot{ψ} ( k ) + {T}_{s} ( ( \frac{- {aC}_{f} + {bC}_{r}}{{I}_{zz} {V}_{x} ( k )} ) {V}_{y} ( k ) + ( \frac{- {a}^{2} {C}_{f} - {b}^{2} {C}_{r}}{{I}_{zz} {V}_{x} ( k )} ) \dot{ψ} ( k ) + ( \frac{{aC}_{f}}{{I}_{zz}} ) {δ}_{f} ) ; and \qquad equation 8$$

$${V}_{x} ( k + 1 ) = {V}_{x} ( k ) . \qquad equation 9$$

Next, in step 54, the state Jacobian of the system matrix A is determined using Taylor series expansion, which is obtained by finding the partial derivatives of equations 7, 8, and 9 with respect to the state vector, as follows:

$${A}_{J} = [ \begin{matrix}1 & 0 & 0 \\ 0 & 1 & 0 \\ 0 & 0 & 1\end{matrix} ] + {T}_{s} [ \begin{matrix}\frac{\begin{matrix}- {C}_{f} - \\ {C}_{r}\end{matrix}}{{M}_{v} {V}_{x} ( k )} & \frac{\begin{matrix}- {aC}_{f} + \\ {bC}_{r}\end{matrix}}{{M}_{v} {V}_{x} ( k )} - {V}_{x} ( k ) & \frac{\begin{matrix}( {C}_{f} + {C}_{r} ) {V}_{y} ( k ) + \\ ( {aC}_{f} - {bC}_{r} - \\ {M}_{v} {V}_{x}^{2} ( k ) ) \dot{ψ} ( k )\end{matrix}}{{M}_{v} {V}_{x}^{2} ( k )} \\ \frac{\begin{matrix}- {aC}_{f} + \\ {bC}_{r}\end{matrix}}{{I}_{zz} {V}_{x} ( k )} & \frac{\begin{matrix}- {a}^{2} {C}_{f} - \\ {b}^{2} {C}_{r}\end{matrix}}{{I}_{zz} {V}_{x} ( k )} & \frac{\begin{matrix}( {aC}_{f} - {bC}_{r} ) {V}_{y} ( k ) + \\ ( {a}^{2} {C}_{f} + \\ {b}^{2} {C}_{r} ) \dot{ψ} ( k )\end{matrix}}{{I}_{zz} {V}_{x}^{2} ( k )} \\ 0 & 0 & 0\end{matrix} ]$$

The resulting discretized and linearized state space model is given as equation 10:

$$x ( k + 1 ) = ( {I}_{3} + {T}_{s} [ \begin{matrix}\frac{- {C}_{f} - {C}_{r}}{{M}_{v} {V}_{x} ( k )} & \frac{- {aC}_{f} + {bC}_{r}}{{M}_{v} {V}_{x} ( k )} - {V}_{x} ( k ) & \frac{\begin{matrix}( {C}_{f} + \\ {C}_{r} ) {V}_{y} ( k ) + \\ ( {aC}_{f} - {bC}_{r} - \\ {M}_{v} {V}_{x}^{2} ( k ) ) \dot{ψ} ( k )\end{matrix}}{{M}_{v} {V}_{x}^{2} ( k )} \\ \frac{- {aC}_{f} + {bC}_{r}}{{I}_{zz} {V}_{x} ( k )} & \frac{- {a}^{2} {C}_{f} - {b}^{2} {C}_{r}}{{I}_{zz} {V}_{x} ( k )} & \frac{\begin{matrix}( {aC}_{f} - \\ {bC}_{r} ) {V}_{y} ( k ) + \\ ( {a}^{2} {C}_{f} + \\ {b}^{2} {C}_{r} ) \dot{ψ} ( k )\end{matrix}}{{I}_{zz} {V}_{x}^{2} ( k )} \\ 0 & 0 & 0\end{matrix} ] ) \\ [ \begin{matrix}{V}_{y} ( k ) \\ \dot{φ} ( k ) \\ {V}_{x} ( k )\end{matrix} ] + [ \begin{matrix}\frac{{C}_{f}}{{M}_{v}} \\ \frac{{aC}_{f}}{{I}_{zz}}\end{matrix} ] {δ}_{f} .$$

In step 56, the Jacobian Cⱼ of the measurement matrix C is determined using Taylor series expansion:

$${C}_{J} = [ \begin{matrix}0 & 1 & 0 \\ \frac{- {C}_{f} - {C}_{r}}{{M}_{v} {V}_{x}} & \frac{- {aC}_{f} + {bC}_{r}}{{M}_{v} {V}_{x}} & \frac{\begin{matrix}( {C}_{f} + {C}_{r} ) {V}_{y} ( k ) + \\ ( {aC}_{f} - {bC}_{r} ) \dot{ψ} ( k )\end{matrix}}{{M}_{v} {V}_{x}^{2} ( k )}\end{matrix} ]$$

In step 58, the state vector and error covariance matrix are initialized. The state vector

$$x ( 0 ) = [ \begin{matrix}{V}_{y} ( 0 ) \\ \dot{φ} ( 0 ) \\ {V}_{x} ( 0 )\end{matrix} ]$$

can be randomly initialized with physically reasonable values, and in at least some implementations, is initialized to zero. The error covariance matrix P can be initialized to the identity 3×3 matrix given by

$${I}_{3} = [ \begin{matrix}1 & 0 & 0 \\ 0 & 1 & 0 \\ 0 & 0 & 1\end{matrix} ]$$

for the third order system.

Next, in step 60, the process and measurement covariance Q and R are defined, which are design matrices that may be tuned by trial and error. Q is a 3×3 matrix in the third order system, and R is a 2×2 matrix because there are two measurements used.

In step 62, the state Jacobian Aⱼ obtained in step 54 is updated, and a next state vector and error covariance matrix is predicted:

$$x ( k + 1 ) = ( {I}_{3} + {T}_{s} {A}_{J} ) [ \begin{matrix}{V}_{y} ( k ) \\ \dot{φ} ( k ) \\ {V}_{x} ( k )\end{matrix} ] + [ \begin{matrix}\frac{{C}_{f}}{{M}_{v}} \\ \frac{{aC}_{f}}{{I}_{zz}} \\ 0\end{matrix} ] {δ}_{f} ; and$$

$$P ( k + 1 ) = {A}_{J} P ( k ) {A}_{J}^{T} + Q .$$

And the measurement Jacobian Cⱼ, obtained in step 56, is updated, and then a residual covariance and Kalman gain are determined:

$$S = {C}_{J} P ( k ) {C}_{J}^{T} + R ; and$$

$$K = P ( k ) {C}_{J}^{T} {S}^{- 1} .$$

In step 64, the measurement vector from

$$y = [ \begin{matrix}\dot{φ} \\ {a}_{y}\end{matrix} ]$$

is obtained from the IMU and the measurement residual error ϵ=y−Cⱼx(k) is computed.

In step 66, the covariance matrix and state vector are updated, P(k+1)=(I−KCⱼ)P(k), where I is the identity 3×3 matrix, and x(k+1)=x(k)+Kϵ.

In step 68, the lateral velocity and yaw rates determined are provided to one or more control systems or schemes, and the process may return to step 60 for new estimations based upon new measurements. By the methods taught herein, accurate and continually updated and corrected lateral velocity and yaw rate information can be provided to vehicle control systems for improved vehicle control, including autonomous vehicle control. The methods take into account and function well with varying longitudinal speeds/accelerations, and do not rely upon an assumption of constant longitudinal velocity, and do not require the intensive efforts to tune the model for different velocities, nor interpolate between breakpoints.

In the method 70 of FIG. 4, in step 72 the dynamical, nonlinear bicycle model is defined to account for varied longitudinal speed/acceleration of the vehicle. In step 74, Taylor series expansions are applied to system and measurement matrices of the system, to linearize the nonlinear, third-order system. In step 76, a nonlinear Kalman filter is defined enabling, in step 78, estimation of lateral acceleration and yaw rate for the vehicle. This information is outputted in step 80 for use by one or more control systems or control schemes of the vehicle. Inputs to the method, in at least some implementations, include measurements from sensors for lateral acceleration, yaw rate, steering angle and longitudinal speed. From this, and with the dynamical bicycle model, Taylor series expansions and nonlinear Kalman filter, accurate estimates can be determined for both lateral acceleration and yaw rate, to enable improved vehicle control.

Methods that utilize kinematic bicycle models work only at very low speeds, and fail at high speeds because they ignore tire forces which increase at higher speeds. This makes such models unsuitable for automated highway vehicles. Models that utilize GPS-based data are dependent upon the availability and accuracy of the GPS data, and do not work well in areas where GPS signal strength might vary or be low, such as urban environments where tall buildings and urban canyons can prevent access to GPS satellite signals.

Pacejka tire models are empirical models and utilize a high number of parameters (e.g. over 90 parameters) that are difficult to determine and take up memory in the control system. The parameters are determined experimentally and are specific to the particular tire model that is installed in the vehicle. The parameters come from the tire supplier, and if the tires on a vehicle are changed to a different type, the parameters are no longer valid, and it follows that the lateral velocity estimates are no longer valid. Dugoff tire models require estimation of a surface friction coefficient, which is not easy to obtain, and is not needed for normal highway driving. Should be vehicle begin to slide on icy roads, for example, the electronic stability control (ESC) system can be employed to stabilize the vehicle such that the complexity of a Dugoff tire model is not needed.

By using a dynamical bicycle model that is not limited to use of a constant longitudinal speed (e.g. zero longitudinal acceleration), the lateral velocity and yaw rate for a vehicle can be estimated for the range of vehicle longitudinal velocities to enable improved lateral control of the vehicle, including during autonomous vehicle driving. The system is thus a third order system instead of a second order system. With this, a nonlinear filter, such as an extended Kalman filter (EKF) is designed and Taylor series expansions are used to account for (e.g. linearize) the nonlinearity of the third order system with changing longitudinal velocities. Accurate estimates can continually be updated and provided to vehicle control systems over a wide range of vehicle operating conditions and over a wide range of vehicle speeds. Further, the system can utilize measurements from low-cost sensors to enable accurate estimations without incurring the cost of expensive, calibrated and more accurate sensors.

What is claimed is:

1. A method for estimating lateral velocity and yaw rate for a vehicle, with a nonlinear dynamical bicycle model, comprising:
determining a state Jacobian of a system matrix using Taylor series expansion;
determining a measurement matrix Jacobian using Taylor series expansion;
initializing a state vector and a covariance matrix for a third order system;
updating the state Jacobian as a function of a measured lateral acceleration, a measured yaw rate and a measured longitudinal vehicle speed;
predicting a next state vector and an error covariance;
updating the measurement matrix Jacobian;
determining a residual covariance and a Kalman gain;
obtaining the measured lateral acceleration and the measured yaw rate;
determining a measurement residual error; and
estimating the lateral velocity and the yaw rate of the vehicle.

2. The method of claim 1 which also includes updating the covariance matrix and the state vector with the estimated lateral velocity and the estimated yaw rate.

3. The method of claim 2 which also includes, to provide an updated estimation of the lateral velocity and an updated estimation of the yaw rate, performing again the steps of:
updating the state Jacobian as a function of a measured lateral acceleration, a measured yaw rate, a measured steering angle and a measured longitudinal vehicle velocity;
predicting a next state vector and an error covariance;
updating the measurement matrix Jacobian;
determining a residual covariance and a Kalman gain;
obtaining the measured lateral acceleration and the measured yaw rate;
determining a measurement residual error; and
estimating the lateral velocity and the yaw rate of the vehicle.

4. The method of claim 1 which also includes providing an output to a control system including the estimated lateral velocity and the estimated yaw rate.

5. The method of claim 1 wherein the measured lateral acceleration and the measured yaw rate are obtained from an accelerometer of the vehicle.

6. The method of claim 5 wherein the accelerometer is an inertial measurement unit (IMU).

7. The method of claim 1 wherein the dynamical bicycle model is discretized using Euler approximation.

8. The method of claim 1 wherein in the step of initializing the state vector, the state vector is initialized to zero.

9. The method of claim 1 wherein the covariance matrix is an identity 3×3 matrix given by
$${I}_{3} = [ \begin{matrix}1 & 0 & 0 \\ 0 & 1 & 0 \\ 0 & 0 & 1\end{matrix} ] .$$

10. The method of claim 1 wherein the state vector is given by
$$x ( k ) = [ \begin{matrix}{V}_{y} ( k ) \\ \dot{ψ} ( k ) \\ {V}_{x} ( k )\end{matrix} ] ,$$
where V_{y} is the vehicle lateral velocity, Vₓ is the vehicle longitudinal velocity, \dot{ψ} is the yaw rate at time (k).

11. The method of claim 1 wherein the measured lateral acceleration (a_{y}) is related to vehicle lateral velocity (V_{y}) and vehicle yaw rate (\dot{ψ}) by the equation: a_{y}=\dot{V}_{y}+Vₓ\dot{ψ}, where Vₓ is the vehicle longitudinal velocity.

12. The method of claim 11 wherein
$${\dot{V}}_{y} = ( \frac{- {C}_{f} - {C}_{r}}{{M}_{v} {V}_{x}} ) {V}_{y} + ( \frac{- {aC}_{f} + b {C}_{r}}{{M}_{v} {V}_{x}} - {V}_{x} ) \dot{ψ} + ( \frac{{C}_{f}}{{M}_{v}} ) {δ}_{f} , and$$
$$\ddot{ψ} = ( \frac{- a {C}_{f} + b {C}_{r}}{{I}_{zz} {V}_{x}} ) {V}_{y} + ( \frac{- {a}^{2} {C}_{f} - {b}^{2} {C}_{r}}{{I}_{zz} {V}_{x}} ) \dot{ψ} + ( \frac{{aC}_{f}}{{I}_{zz}} ) {δ}_{f} ,$$
where:
\ddot{ψ}=vehicle yaw angular acceleration; a=distance from a center of gravity to a front axle of the vehicle; b=distance from the center of gravity to a rear axle; Mᵥ=vehicle mass; I_{zz}=vehicle moment of inertia about the z axis; C_{f}=lumped cornering stiffnesses of a front tire; Cᵣ=lumped cornering stiffnesses of a rear tire; and δ_{f}=the steering angle.

13. The method of claim 11 wherein a measurement model is given by:
$$[ \begin{matrix}\dot{ψ} \\ {a}_{y}\end{matrix} ] = \underbrace{[ \begin{matrix}0 & 1 \\ \frac{- {C}_{f} - {C}_{r}}{{M}_{v} {V}_{x}} & \frac{- a {C}_{f} + b {C}_{r}}{{M}_{v} {V}_{x}}\end{matrix} ]}_{C} [ \begin{matrix}{V}_{y} \\ \dot{ψ}\end{matrix} ] + [ \begin{matrix}0 \\ \frac{{C}_{f}}{{M}_{v}}\end{matrix} ] {δ}_{f} ,$$
and the step of determining a measurement matrix Jacobian using Taylor series expansion is given by:
$${C}_{J} = [ \begin{matrix}0 & 1 & 0 \\ \frac{- {C}_{f} - {C}_{r}}{{M}_{v} {V}_{x} ( k )} & \frac{- a {C}_{f} + b {C}_{r}}{{M}_{v} {V}_{x} ( k )} & \frac{( {C}_{f} + {C}_{r} ) {V}_{y} ( k ) + ( a {C}_{f} - b {C}_{r} ) \dot{ψ} ( k )}{{M}_{v} {V}_{x}^{2} ( k )}\end{matrix} ] ,$$
where:
a=distance from a center of gravity to a front axle of the vehicle; b=distance from the center of gravity to a rear axle; Mᵥ=vehicle mass; C_{f}=lumped cornering stiffnesses of a front tire; Cᵣ=lumped cornering stiffnesses of a rear tire; and δ_{f}=the steering angle.

14. A method for estimating lateral velocity and yaw rate for a vehicle, comprising:
defining a dynamical bicycle model for a vehicle system with variable longitudinal velocity and two degrees of freedom, where the degrees of freedom relate to lateral velocity and yaw angle, and where a state representation of the system is given by \dot{x}=Ax+Bu, A is a system matrix that is nonlinear;
applying Taylor series expansion to linearize the A system matrix
defining a nonlinear Kalman filter for the system including a measurement model with a measurement matrix C;
applying Taylor series expansion to linearize the measurement matrix C; and
estimating the lateral velocity and the yaw rate of the vehicle as a function of the dynamical bicycle model and the nonlinear Kalman filter.

15. The method of claim 14 wherein the step of estimating includes:
determining a state Jacobian of the system matrix A;
determining a Jacobian of the measurement matrix C;
initializing a state vector and a covariance matrix for the system;
updating the state Jacobian as a function of a measured lateral acceleration, a measured yaw rate and a measured longitudinal vehicle speed;
predicting a next state vector and an error covariance;
updating the measurement matrix Jacobian;
determining a residual covariance and a Kalman gain;
obtaining the measured lateral acceleration and the measured yaw rate; and
determining a measurement residual error.

16. The method of claim 14 wherein the predicted lateral acceleration
$${\dot{V}}_{y} = ( \frac{- {C}_{f} - {C}_{r}}{{M}_{v} {V}_{x}} ) {V}_{y} + ( \frac{- {aC}_{f} + b {C}_{r}}{{M}_{v} {V}_{x}} - {V}_{x} ) \dot{ψ} + ( \frac{{C}_{f}}{{M}_{v}} ) {δ}_{f} ,$$
and the yaw angle acceleration
$$\ddot{ψ} = ( \frac{- a {C}_{f} + b {C}_{r}}{{I}_{zz} {V}_{x}} ) {V}_{y} + ( \frac{- {a}^{2} {C}_{f} - {b}^{2} {C}_{r}}{{I}_{zz} {V}_{x}} ) \dot{ψ} + ( \frac{{aC}_{f}}{{I}_{zz}} ) {δ}_{f} ,$$
and a state space representation of the system is given by \dot{x}=Ax+Bu; wherein:
$$\underbrace{[ \begin{matrix}{\dot{V}}_{y} \\ \ddot{ψ}\end{matrix} ]}_{\dot{x}} = \underbrace{[ \begin{matrix}- \frac{{C}_{f} + {C}_{r}}{{M}_{v} {V}_{x}} & \frac{- a {C}_{f} + b {C}_{r}}{{M}_{v} {V}_{x} ( k )} - {V}_{x} \\ \frac{- a {C}_{f} + b {C}_{r}}{{I}_{zz} {V}_{x}} & - \frac{{a}^{2} {C}_{f} - {b}^{2} {C}_{r}}{{I}_{zz} {V}_{x}}\end{matrix} ]}_{A} \underbrace{[ \begin{matrix}{V}_{y} \\ \dot{ψ}\end{matrix} ]}_{x} + \underbrace{[ \begin{matrix}\frac{{C}_{f}}{{M}_{v}} \\ \frac{{aC}_{f}}{{I}_{zz}}\end{matrix} ]}_{B} \underbrace{{δ}_{f}}_{u} ,$$
where A is a system matrix and wherein:
\dot{ψ}=vehicle yaw rate;
\ddot{ψ}=vehicle yaw angular acceleration;
Vₓ=vehicle velocity component along the x axis (longitudinal velocity);
V_{y}=vehicle velocity component along the y axis (lateral velocity);
a=distance from center of gravity to front axle;
b=distance from center of gravity to rear axle;
Mᵥ=vehicle mass;
I_{zz}=vehicle moment of inertia about the z axis;
C_{f}=lumped cornering stiffnesses of the front tire;
Cᵣ=lumped cornering stiffnesses of the rear tire; and
δ_{f}=front tire steering angle.

17. The method of claim 16 wherein lateral acceleration a_{y}=\dot{V}_{y}+Vₓ\dot{ψ}, and a measurement model is defined in state space representation as:
$$[ \begin{matrix}\dot{ψ} \\ {a}_{y}\end{matrix} ] = \underbrace{[ \begin{matrix}0 & 1 \\ \frac{- {C}_{f} - {C}_{r}}{{M}_{v} {V}_{x}} & \frac{- a {C}_{f} + b {C}_{r}}{{M}_{v} {V}_{x}}\end{matrix} ]}_{C} [ \begin{matrix}{V}_{y} \\ \dot{ψ}\end{matrix} ] + [ \begin{matrix}0 \\ \frac{{C}_{f}}{{M}_{v}}\end{matrix} ] {δ}_{f} ,$$
wherein C is a measurement matrix.

18. The method of claim 17 wherein the method includes determining a state Jacobian Aⱼ which is the Jacobian of the system matrix A using Taylor series expansion and determining a measurement Jacobian Cⱼ which is the Jacobian of the measurement matrix C using Taylor series expansion.

19. The method of claim 18 which includes:
initializing the state vector as
$$x ( 0 ) = [ \begin{matrix}{V}_{y} ( 0 ) \\ \dot{ψ} ( 0 ) \\ {V}_{x} ( 0 )\end{matrix} ] ,$$
and initializing the error covariance matrix
$$P as {I}_{3} = [ \begin{matrix}1 & 0 & 0 \\ 0 & 1 & 0 \\ 0 & 0 & 1\end{matrix} ] ;$$
defining a process covariance Q and a measurement covariance R;
updating the state Jacobian Aⱼ and predicting the next state vector as
$$x ( k + 1 ) = ( {I}_{3} + {T}_{s} {A}_{J} ) [ \begin{matrix}{V}_{y} ( k ) \\ \dot{ψ} ( k ) \\ {V}_{x} ( k )\end{matrix} ] + [ \begin{matrix}\frac{{C}_{f}}{{M}_{v}} \\ \frac{a {C}_{f}}{{I}_{zz}} \\ 0\end{matrix} ] {δ}_{f} ,$$
and predicting the next error covariance matrix as
$$P ( k + 1 ) = {A}_{J} P ( k ) {A}_{J}^{T} + Q ;$$
updating the measurement Jacobian Cⱼ and determining a residual covariance and a Kalman gain as
$$S = {C}_{J} P ( k ) {C}_{J}^{T} + R ; and K = P ( k ) {C}_{J}^{T} {S}^{- 1} ;$$
and
computing the measurement residual error based on measured values for lateral acceleration and yaw rate, where the measurement residual error ϵ=y−Cⱼx(k).
